(19) United States
(12) Patent Application Publication
(10) Pub. No.: US 2009/0158247 A1
(43) Pub. Date: Jun. 18, 2009

(54) METHOD AND SYSTEM FOR THE EFFICIENT UNROLLING OF LOOP NESTS WITH AN IMPERFECT NEST STRUCTURE

(75) Inventor: Arie Tal, Toronto (CA)

Correspondence Address: IBM CORPORATION, (OLP);c/o ORTIZ & LOPEZ, PLLC, P.O. BOX 4484, ALBUQUERQUE, NM, 87196-4484, US

(73) Assignee: International Business Machines Corporation

(21) Appl. No.: 11/956,592

(22) Filed: Dec. 14, 2007

(51) Int. Cl. G06F 9/44

(52) U.S. Cl. 717/106

(57) ABSTRACT

A computer implemented method system and computer program product for efficient unrolling of imperfect loop nests. A virtual iteration space can be determined based on a UF (Unroll Factor) and the iteration space for each dimension of a nested loop can be divided into a residual iteration space and a non-residual iteration space utilizing unroll-and-jam transformation. The non-residual iteration space for one dimension can be utilized for categorizing the residual and non-residual iteration space for next dimension. This approach can be applied recursively to all dimensions and the non-residual iteration from last dimension can be removed in order to get a clean perfect loop nest. Such an approach can also be applied to triangular loop nests and nested loops having three or more dimensions.

### TECHNICAL FIELD

Embodiments are generally related to data-processing systems and methods. Embodiments also relate in general to the field of computers and similar technologies, and in particular to software utilized in this field. In addition, embodiments relate to loop nest structures.

### BACKGROUND OF THE INVENTION

A loop is a repetitive sequence of computations in a computer program, commonly defining a CIV (Controlling Induction Variable). The CIV can be initialized to a lower bound before the loop begins and can be then incremented by a fixed value at each loop iteration, and its current value can be tested against an upper bound as a stopping condition for the loop. A collection of loops contained within a single parent loop is called a loop nest structure.

The loop nest structures can be utilized for computations that involve multidimensional arrays such as vectors, matrices, etc., where the loop's CIVs can be utilized for accessing array members. In such computations it can be preferable to unroll the parent loop by a fixed number of iterations called unroll factor and fuse the child loop nests to form a single perfectly nested loop nest. This form of optimization is known as unroll and jam, which improves computation performance by reusing some of the array elements being accessed in subsequent iterations of the parent loop.

Loop unrolling is a well known program transformation utilized by programmers and program optimizers to improve the instruction-level parallelism and register locality and to decrease branching overhead of program loops. Residues form the portion of the loop that cannot be executed when the loop is unrolled by the unroll factor. That is, since the controlling induction variable of the unrolled outer loop is advanced a fixed number of times in every iteration, if the upper bound does not divide evenly by the unroll factor i.e., when there is a remainder or, the modulus of the upper bound of the outer loop induction variable and the unroll factor is not zero, then code must be generated to address the remaining portion of the residue. The code generated to handle these residues may add overhead and inefficiencies that can result in performance degradation.

An exemplary two dimensional nested loop having an outer loop with an induction variable “i” and an inner loop with an induction variable “j” is illustrated below as Nested Loop Source Code Example 1:

### EXAMPLE 1

Nested loop source code

```
int i, j, a[20][20], c[20][20], b[20], n;
n = 7;
for (int i = 0; i < n; i++) {
    for (int j = 0; j < n; j++){
        c[j][i] = a[j][i] + b[j];
    }
}
```

The induction variable “i” and “j” of example 1 are both unrolled and jammed by an unroll factor of two utilizing a prior art approach as illustrated in TABLE 1. The program code replicates the original loop nest of Example 1 for each dimension of “i” and “j” being unrolled and then alerts the bounds of the generated nests to cause them to traverse through the residual iterations of the dimension being handled. The program code illustrated in TABLE 1 includes a separate unroll stage and fuse stage for each dimension of “i” and “j” which generally reduces compile-time efficiency and cause performance degradation.

TABLE 1

| | |
|---|---|
| for(int i = 0; i < n % 2; i++){ | |
| for(int j = 0; j < n; j++){ | |
| loop body | //Residue for i |
| } | |
| } | |
| for(int i = n % 2; i < n; i++){ | |
| for(int j = 0; j < n % 2; j++){ | |
| loop body | //Residue for j |
| } | |
| } | |
| for(int i = n % 2; i < n; i=i+2){ | |
| for(int j = n % 2; j < n; j=j+2){ | |
| loop body | |
| } | |
| } | |

Note that only outer loops can be unrolled-and-jammed. The ‘jamming’ effect discussed above refers to taking the copies of their “child” loops and jamming them together to form a single child loop.

```
For example,
for (i=0; i<n; i++)
  for (j=0; j < m; j++)
    a[i][j] = a[i][j]+b[j];
unrolling the outer loop (the i-loop) by a factor of 2 would produce (if
we ignore the residue for this example):
for (i=0; i<n; i+=2) {
  for (j=0; j < m; j++)
    a[i][j] = a[i][j]+b[j];
  for (j=0; j < m; j++)
    a[i+1][j] = a[i+1][j]+b[j];
}
```

Now the ‘jamming’ (or ‘fusing’) effect, will convert the two j-loops into a single loop that does both statements, and produce:

```
for (i=0; i<n; i+=2) {
  for (j=0; j < m; j++) {
    a[i][j] = a[i][j]+b[j];
    a[i+1][j] = a[i+1][j]+b[j];
  }
}
```

Now the j-loop can be unrolled if preferred (e.g. by a factor of 2), which would produce (again, ignoring residue):

```
for (i=0; i<n; i+=2) {
  for (j=0; j < m; j+=2) {
    a[i][j] = a[i][j]+b[j];
    a[i+1][j] = a[i+1][j]+b[j];
    a[i][j+1] = a[i][j+1]+b[j+1];
    a[i+1][j+1] = a[i+1][j+1]+b[j+1];
  }
}
```

As one can see, the j-loop is unrolled, but since it does not contain any child loops, there is no ‘jamming’ for that loop. Thus, the “outer loop” with an induction variable “l” is being unrolled and jammed by an unroll factor of two, and the innermost loop with induction variable “j” is being unrolled by a factor of two utilizing the prior art approach discussed above.

Referring to FIG. 3, a prior art two-dimensional view of an iteration space 300 for the exemplary nested loop source code is illustrated. Note that the set of iterations that the CIV of the loop traverses from lower bound to upper bound is referred to as the “iteration space”. The rectangular iteration space 300 comprises the set of all values in the induction variables in all the iterations of the loop nests. The rectangular iteration space defined for the code in TABLE 1 is illustrated in FIG. 3. Each unroll and jammed version of the loop body corresponds to a square 330 in the iteration space 300.

The iteration space of the residual nest for “i” dimension 310 overlaps the residual iteration space for “j” dimension 320. The overlapping results in a duplicate traversal of the iteration space 300. Unfortunately, this approach does not provide an easy way to deal with the independence of each replica of the original loop nest and the lack of sense of coordination between the generated residual nests. As a result, bounds of more than one dimension need to be altered for each residual nest, even though only one dimension is being handled.

The creation of the residue causes perfect triangular nested loops i.e., nested loops where the inner loop induction variable “j” is bounded on the upper end by the value of the outer loop induction variable “i” to no longer be “perfect”. As a result, other optimization techniques which are only applicable to perfect loop nests cannot be additionally applied. The prior art-and-jam approach depicted in FIG. 3 is limited to handling imperfect loop nests and also to re-calculating unroll factors of two dimensions with a triangular relationship since the residual iteration space for these loops does not constitute a contiguous set of indices. This approach makes calculation of residual bounds for the triangular loops a complex task especially when there are multiple loops nested inside each other.

Therefore, a need exists for an improved method and system for performing an extended unroll-and-jam transformation that can handle imperfect loop nests and loop nests that contain loops with bounds that are linear functions of the CIV of the nested loops.

### BRIEF SUMMARY

The following summary is provided to facilitate an understanding of some of the innovative features unique to the present invention and is not intended to be a full description. A full appreciation of the various aspects of the embodiments disclosed herein can be gained by taking the entire specification, claims, drawings, and abstract as a whole.

It is, therefore, one aspect of the present invention to provide for an improved data-processing method, system and computer-usable medium.

It is another aspect of the present invention to provide for a method, system and computer-usable medium for performing efficient unrolling of imperfect loop nests.

The aforementioned aspects and other objectives and advantages can now be achieved as described herein. A computer implemented method, system and computer program product for efficient unrolling of imperfect loop nests. A virtual iteration space can be determined based on an unroll factor (UF) and the iteration space for each dimension of a nested loop can be divided into a residual iteration space and a non-residual iteration space utilizing unroll-and-jam transformation. The non-residual iteration space for one dimension can be utilized for categorizing the residual and non-residual iteration space for next dimension. This approach can be applied recursively to all dimensions and the non-residual iteration from last dimension can be removed in order to get a clean perfect loop nest. This method can also be applied to triangular loop nests and nested loops having three or more dimensions.

The residual iterations can be either traversed at the beginning of the iteration space as a “head residue” or at the end of the iteration space as a “tail residue”. The child loop and an intervening code of an imperfectly nested loop can be replicated and the intervening code can be moved to either the beginning or the end of the loop in order to fuse the child loop into a single child loop nest. The method and system disclosed in greater detail herein results in an efficient compile time direct loop optimization transformation. This method can also be able to handle the imperfect loop nests with an improved overall run-time performance for program execution.

### BRIEF DESCRIPTION OF THE DRAWINGS

The accompanying figures, in which like reference numerals refer to identical or functionally-similar elements throughout the separate views and which are incorporated in and form a part of the specification, further illustrate the present invention and, together with the detailed description of the invention, serve to explain the principles of the present invention.

FIG. 1 illustrates a schematic view of a computer system in which the present invention may be embodied;

FIG. 2 illustrates a schematic view of a software system including an operating system, application software, and a user interface for carrying out the present invention;

FIG. 3 illustrates a prior art diagrammatic view of a residual iteration space of a loop nest;

FIG. 4 illustrates a high-level logical flowchart of operations illustrating an exemplary method for efficient unrolling of loop nests with imperfect nest structure, which can be implemented in accordance with a preferred embodiment;

FIG. 5A illustrates a diagrammatic view of a residual iteration space of dimension “i” for an exemplary two-dimensional loop, which can be implemented in accordance with a preferred embodiment;

FIG. 5B illustrates a diagrammatic view of a residual iteration space of dimension “j” for the exemplary two-dimensional loop, which can be implemented in accordance with a preferred embodiment;

FIG. 6A illustrates a diagrammatic view of an iteration space for an exemplary two-dimensional triangular loop, which can be implemented in accordance with a preferred embodiment;

FIG. 6B illustrates a diagrammatic view of a residual iteration space of dimension “i” for the exemplary two-dimensional triangular loop, which can be implemented in accordance with a preferred embodiment;

FIG. 7A illustrates a diagrammatic view of a residual iteration space of dimension “i” for generating slicing loop for the exemplary two-dimensional triangular loop, which can be implemented in accordance with a preferred embodiment;

FIG. 7B illustrates a diagrammatic view of a residual iteration space of dimension “j” for the exemplary two-dimensional triangular loop, which can be implemented in accordance with a preferred embodiment;

FIG. 8 illustrates a three-dimensional visualization of an iteration space for an exemplary three-dimensional nested loop, which can be implemented in accordance with an alternative embodiment;

### DETAILED DESCRIPTION

The particular values and configurations discussed in these non-limiting examples can be varied and are cited merely to illustrate at least one embodiment and are not intended to limit the scope of such embodiments.

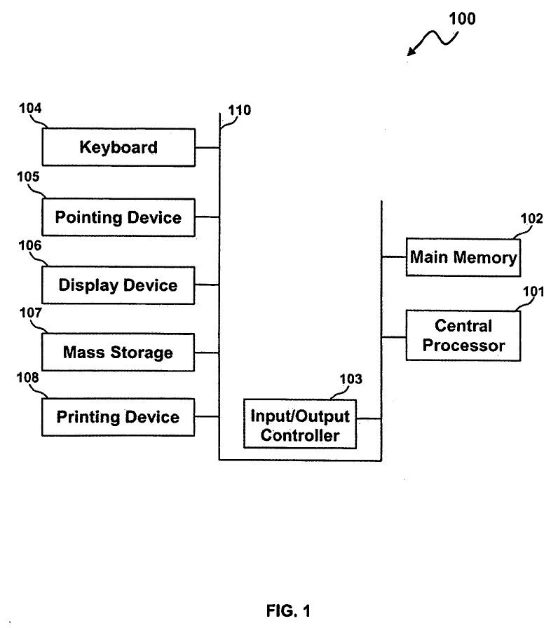

As depicted in FIG. 1, the present invention may be embodied on a data-processing system 100 comprising a central processor 101, a main memory 102, an input/output controller 103, a keyboard 104, a pointing device 105 (e.g., mouse, track ball, pen device, or the like), a display device 106, and a mass storage 107 (e.g., hard disk). Additional input/output devices, such as a printing device 108, may be included in the data-processing system 100 as desired. As illustrated, the various components of the data-processing system 100 communicate through a system bus 110 or similar architecture.

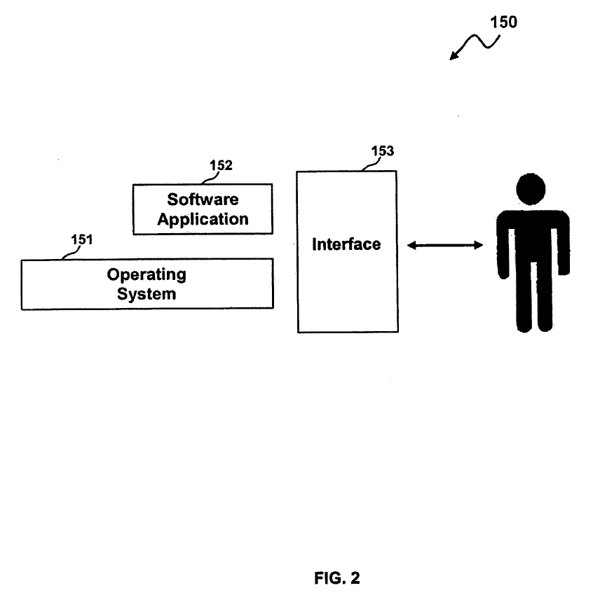

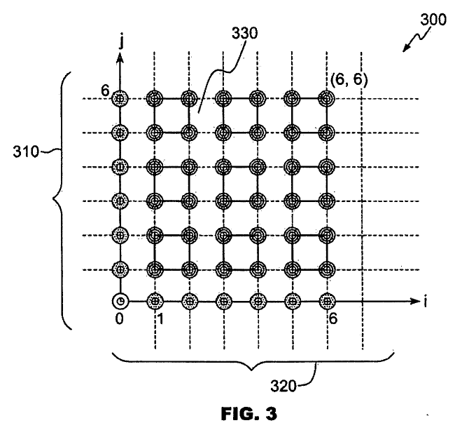

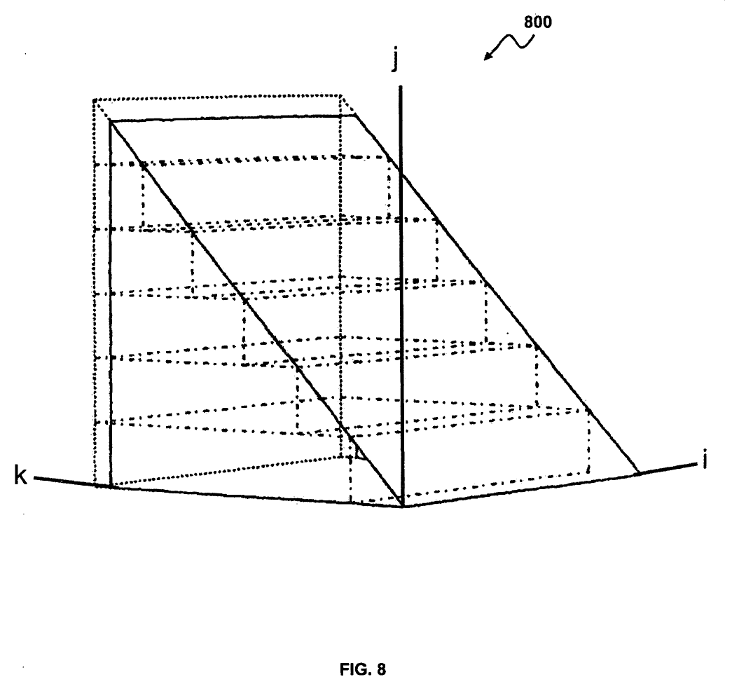

Illustrated in FIG. 2, a computer software system 150 is provided for directing the operation of the data-processing system 100. Software system 150, which is stored in system memory 102 and on disk memory 107, includes a kernel or operating system 151 and a shell or interface 153. One or more application programs, such as application software 152, may be “loaded” (i.e., transferred from storage 107 into memory 102) for execution by the data-processing system 100. The data-processing system 100 receives user commands and data through user interface 153; these inputs may then be acted upon by the data-processing system 100 in accordance with instructions from operating module 151 and/or application module 152. The interface 153, which is preferably a graphical user interface (GUI), also serves to display results, whereupon the user may supply additional inputs or terminate the session. In an embodiment, operating system 151 and interface 153 can be implemented in the context of a “Windows” system. Application module 152, on the other hand, can include instructions, such as the various operations described herein with respect to respective method 800 of FIG. 8.

The following description is presented with respect to embodiments of the present invention, which can be embodied in the context of a data-processing system such as data-processing system 100 and computer software system 150 depicted in FIGS. 1-2. The present invention, however, is not limited to any particular application or any particular environment. Instead, those skilled in the art will find that the system and methods of the present invention may be advantageously applied to a variety of system and application software, including database management systems, word processors, and the like. Moreover, the present invention may be embodied on a variety of different platforms, including Macintosh, UNIX, LINUX, and the like. Therefore, the description of the exemplary embodiments, which follows, is for purposes of illustration and not considered a limitation.

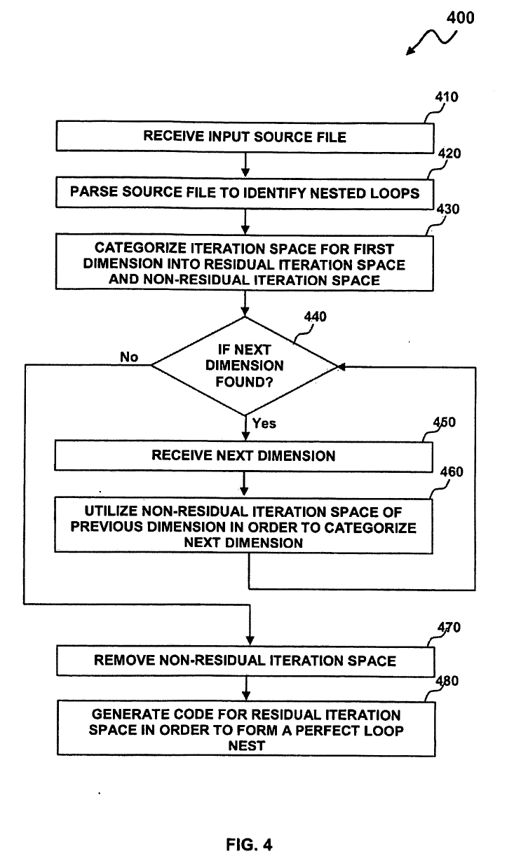

Referring to FIG. 4, a high-level logical flowchart of operations illustrating an exemplary method 400 for efficient unrolling of loop nests with imperfect nest structure is illustrated, which can be implemented in accordance with a preferred embodiment. Note that the method 400 depicted in FIG. 4 can be implemented in the context of a software module such as, for example, the application module 152 of computer software system 150 depicted in FIG. 2. An input source file can be received, as shown at block 410. The input source file can be a conventional source code of any source code language including looping structures for e.g., for-next loops, for loops, while loops, loop untils, do loops; etc. This includes a nested loop of “n” dimension where “n”>=2 with the upper and lower bounds of the loops are either loop nest invariant or a linear function of some outer loop induction variable.

An exemplary two dimensional nested loop having an outer loop with an induction variable “i” and an inner loop with an induction variable “j” is illustrated as Nested Loop Source Code Example 1. The source code file can be parsed in order to identify nested loops, as illustrated at block 420. An iteration space for a first dimension of the nested loop can be categorized into a residual iteration space and a non-residual or remaining iteration space by applying unroll-and-jam transformation, as depicted at block 430. The residual iterations can be either traversed at the beginning of the iteration space as “head residue” or at the end of the iteration space as “tail residue”. The “head residue” can be defined as a residual nest, which traverses the beginning of the iteration space whereas the “tail residue” can be defined as a residual nest traversing the indices at the end of the iteration space. For example, consider TABLE 2 below, which illustrates software code after categorizing a dimension “i” of a two-dimension loop into a residual iteration space and a non-residual or a remaining iteration space.

TABLE 2

| | |
|---|---|
| for(int i = 0; i < n % 2; i++){ | |
| for(int j = 0; j < n; j++){ | |
| loop body | //Residual iteration space of i |
| } | |
| } | |
| for(int i = n % 2; i < n; i++){ | |
| for(int j = 0; j < n; j++){ | |
| loop body | //Remaining iteration space of i |
| } | |
| } | |

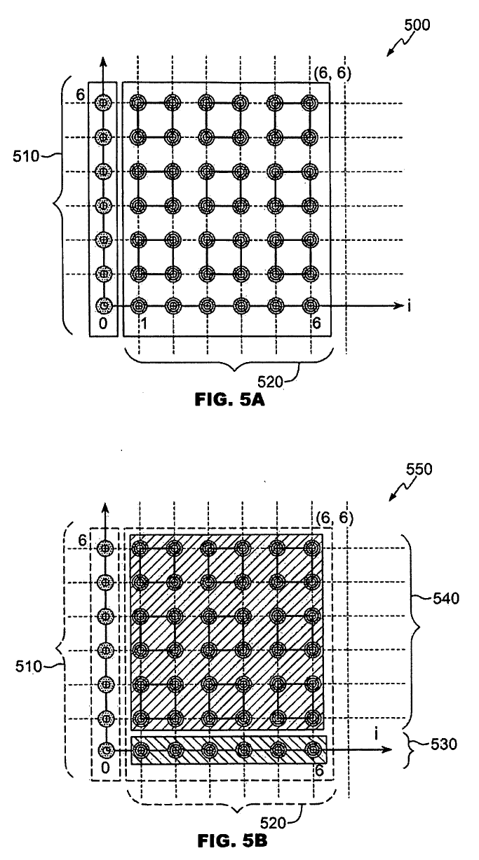

Referring to FIG. 5A, a diagrammatic view of a residual iteration space 500 of dimension “i” for a two-dimensional loop is illustrated, which can be implemented in accordance with a preferred embodiment. The actual iteration space 500 can be formed by the set of all of values of controlling induction variables (CIV) in all of the iterations of the loop nest. For example, in a simple nested loop foiled by an outer loop having an induction variable “i” iterated in increments of one from a value of zero to a value “n” (i.e., i=0, n, 1) and an inner loop having an induction variable “j” iterated in increments of one from a value of zero to a value of “m” (i.e., j=0, m, 1), the iteration space can be composed of those values comprising the data sets (0, 0), (0, 1), (0, 2), . . . (0, m), (1, 0), (1, 1), . . . , (1, m), . . . (n, 0), (n, 1), . . . , (n, m).

The iteration space 500 can be divided into a residual iteration space for “i” dimension 410 and a non-residual or remaining iteration space for “i” dimension 420. The virtual iteration space 500 is dependent upon the unrolling factor (UF). The unroll factor can be determined by a compiler (not shown), user input, or preferably a combination of the two. The remaining iteration space for “i” dimension 420, which are covered by the unroll-and-jam version of the loop, traverses the set of indices for the next dimension “j”. The virtual iteration space 500 can be determined based on the unroll factor (UF) of two. Bracket 510 represents the left hand-side of the graphical representation of residual iteration space 500 depicted in FIG. 5A.

A test can then be performed as depicted at block 440 to determine whether next dimension has been found in the nested loop. If next dimension is found, then the next dimension of the nested loop can be received, as depicted at block 450. Next, as described at block 460 non-residual iteration space of previous dimension can be utilized in order to categorize next dimension of the nested loop into residual iteration space and non-residual iteration space. For example, the code for categorizing dimension ‘j’ utilizing the non-residual iteration space of dimension “i” is illustrated in Table 3.

TABLE 3

| | |
|---|---|
| for(int i = n % 2; i < n; i++){ | //Remaining iteration space of i |
| for(int j = 0; j < n % 2; j++){ | |
| loop body | //Residual iteration space of j |
| } | |
| for(int j = n % 2; j < n; j++){ | |
| loop body | //Remaining iteration space of j |
| } | |
| } | |

Referring to FIG. 5B a diagrammatic view of a residual iteration space 550 of dimension “j” for the exemplary two-dimensional loop is illustrated, which can be implemented in accordance with a preferred embodiment. The remaining or non-residual iteration space for “i” dimension 520, as depicted in FIG. 5B can be utilized for categorizing dimension ‘j’ into residual iteration space 530 and non-residual iteration space 540.

The non-residual iteration space of the last dimension of the nested loop can be removed, as illustrated at block 470. The residual portions of the loop can be determined and code can be generated in order to form a perfect loop nest, as shown at block 480. The residual iteration space 550 of FIG. 5 is two-dimensional, hence the remaining iteration space 540 of “j” can be removed to form perfect loop nest in order to obtain correct results. The bounds of the dimension can be altered when generating the residual nests for dimension “j” without traversing duplicate sets of indices, which results in good coordination between generated residues.

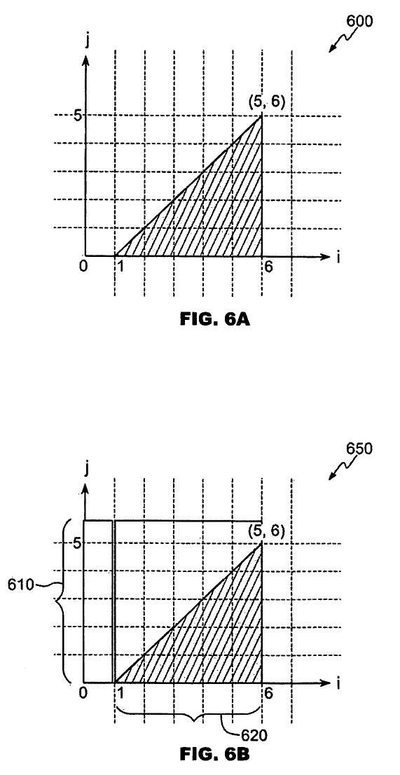

The method 400 can also be applied to triangular loop nests and nested loops having three or more dimensions. For example consider TABLE 4 that includes a two-dimensional triangular loop with “i” and “j” dimensions and the diagrammatic view of the residual iteration space is illustrated in FIG. 6A. The dimension “j” as illustrated in TABLE 4 cannot be unrolled and jammed. However, for the purpose of demonstration of the generation of residue nests for triangular loops, it is assumed that dimension “j” is being unrolled and jammed.

TABLE 4

```
n = 7;
for(int i = 0; i < n ; i++){
    for(int j = 0; j < i; j++){
    loop body
    }
}
```

The residual iteration space for dimension “i” can be calculated as illustrated in TABLE 5. The diagrammatic view of a residual iteration space of dimension “i” for the exemplary two-dimensional triangular nested loop is illustrated at FIG. 6B, which includes the residual iteration space, and non-residual iteration space 610 and 620 for dimension “i”.

TABLE 5

| | |
|---|---|
| for(int i = 0 ; i < n % 2; i++){ | |
| for(int j = 0; j < i; j++){ | |
| loop body | //Residual iteration space of i |
| } | |
| } | |
| for(int i = n % 2; i < n; i++){ | |
| for(int j = 0 ; j < i; j++){ | |
| loop body | //Remaining iteration space of i |
| } | |
| } | |

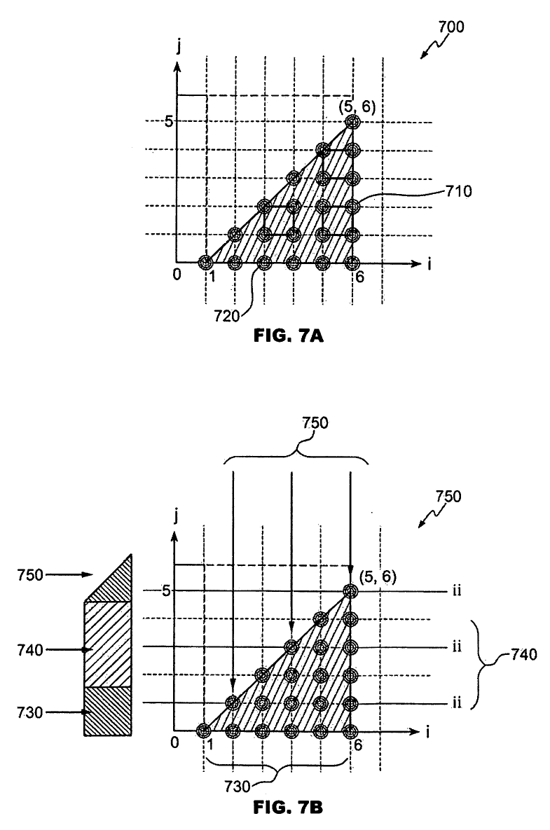

Referring to FIG. 7A, a diagrammatic view of a residual iteration space 700 for generating slicing loop for exemplary triangular nested loop is illustrated, which can be implemented in accordance with a preferred embodiment. The residual iteration space 700 generally includes a set of values covered by the unroll and jammed loop of dimension “i” as shown in FIG. 6B which can be utilized to figure out the set of indices need to be covered by the residual nest for dimension ‘j’. The set of indices such as indices 710, which are brightly colored, are not covered by the unroll and jammed loop body, and the gray dots such as indices 720 correspond to set of indices traversed by the unroll and jammed loop body. The set of residual iterations which are brightly colored are apart from the “i” axis by distances of 1, 3 and 5. These values start from the lower bound of the remaining iteration space 610 of dimension “i”, which can be increased by increments of unroll factor size. A slicing loop can be introduced in order to traverse the set of indices surrounding the “i” loop and traversing the remaining iteration space of “i” as shown in TABLE. 6.

TABLE 6

```
for(int ii = n % 2; ii < n; ii = ii + 2){
    for(int i = ii; i < ii + 2; i++){
        for(int j = 0; j < i; j++){
            loop body
        }
    }
}
```

The slicing loop as shown in TABLE. 6 can be introduced whenever a dimension triangularly depends on the current dimension being handled. The set of indices covered by dimension “j” can easily be categorized into the required sets such as residual iteration space and remaining iteration space utilizing the slicing loop, as follows:

TABLE 7

| | |
|---|---|
| for(int ii = n % 2; ii < n; ii = ii + 2){ | //remaining iteration space for i |
| for(int i = ii; i < ii + 2; i++){ | //remaining iteration space for i |
| for(int j = ii; j < i; j++){ | |
| loop body | //residual iteration space for j |
| } | |
| for(int j = 0; j < ii % 2; j++){ | |
| loop body | //residual iteration space for j |
| } | |
| for(int j = ii % 2; j < ii; j++){ | |
| loop body | //remaining iteration space for j |
| } | |
| } | |
| } | |

FIG. 7B illustrates a diagrammatic view of a residual iteration space 750 for dimension “j” for exemplary two-dimensional triangular nested loop, which can be implemented in accordance with a preferred embodiment. The second residual nest 730 generated for “j” dimension covers the set of point lying on the “i” axis and the first residual nest 740 for dimension “j” covers the remaining set of residual iterations 750 for dimension “j”. The remaining iteration space 750 generated for “j” can be removed as there are no further dimensions to be handled because it can traverse the same set of values as the unroll and jammed loop body. The final transformation result for exemplary two-dimensional triangular nested loop is illustrated in TABLE 8.

The method 400 as illustrated in FIG. 4 can be extended to any number of dimensions required by following the same steps and by recursively applying the categorization on the available dimensions. The remaining iteration space of the dimension can be sliced if a loop is triangularly dependent on the current dimension being handled.

TABLE 8

```
for(int i = 0 ; i < n % 2; i++){
    for(int j = 0; j < i; j++){
        loop body
    }
}
for(int ii = n % 2; ii < n; ii = ii + 2){
    for(int i = ii; i < ii + 2; i++){
        for(int j = ii; j < i; j++){
            loop body
        }
        for(int j = 0; j < ii % 2; j++){
            loop body
        }
    }
}
for(int i = n % 2; i < n; i=i+2){
    for(int j = i % 2; j < i; j=j+2){
        unrolled loop body
    }
}
```

Referring to FIG. 8 a three-dimensional visualization of an iteration space for an exemplary three-dimensional nested loop 800 is illustrated, which can be implemented in accordance with an alternative embodiment. The dimensions “i” and “k” of the three-dimensional nested loop can be initially traversed by the unroll and jammed transformation. The original iteration space 800 can be divided into a residual iteration space and a remaining iteration space for “i” dimension. Next, the dimension “k” can be processed and it can be divided into a residual iteration space and a remaining iteration space.

Since the dimension “j” is triangularly dependent on dimension “k”, the remaining iteration space of the dimension “k” can be surrounded by a slicing loop. Thereafter, the dimension “j” can be finally divided into first residual iteration space, second residual iteration space and remaining iteration spaces using a k-slicer. In order to prevent duplicate traversal of iterations, the remaining and second residual iteration space of “j” dimension can be removed from the generated residual loop nests to get a clear perfect loop. The introduction of the induction variable of the k-slicer can allow separate handling of the two residual spaces for a triangular dimension. This allows processing of triangulated dimensions up to any length without any further complexities. An exemplary transformed code generated for a three-dimensional loop is illustrated in TABLE 9.

```
TABLE 9
/* residual nests */
for(int i = 0; i < n1 % uf; i++){
    for (int k = 0; k < n2; k++){
        for(int j = 0; j < k; j++){
        loop body
        }
    }
}
for(int i = n1 % uf ; i < n1; i++){
    for (int k = 0; k < n2 % uf; k++){
        for(int j = 0; j < k; j++){
            loop body
        }
    }
    for(int kSlicer = n2 % uf; kSlicer < n2, kSlicer = kSlicer + uf){
        for (int k = kSlicer; k < kSlicer + uf; k++){
            for(int j = kSlicer; j < k; j++){
            loop body
            }
        }
    }
}
/* main unroll and jammed loop */
for(int i = n1 % uf; i < n1; i=i+uf){
    for(int k = n2 % uf; k < n2; k=k+uf){
        for(int j = 0; j < k; j=++){
        unrolled loop body
        }
    }
```

It should be understood that at least some aspects of the present invention may alternatively be implemented in a computer-useable medium that contains a program product. For example, the process depicted in FIG. 4 herein can be implemented in the context of a such a program product. Programs defining functions on the present invention can be delivered to a data storage system or a computer system via a variety of signal-bearing media, which include, without limitation, non-writable storage media (e.g., CD-ROM), writable storage media (e.g., hard disk drive, read/write CD ROM, optical media), system memory such as but not limited to Random Access Memory (RAM), and communication media, such as computer and telephone networks including Ethernet, the Internet, wireless networks, and like network systems.

It should be understood, therefore, that such signal-bearing media when carrying or encoding computer readable instructions that direct method functions in the present invention, represent alternative embodiments of the present invention. Further, it is understood that the present invention may be implemented by a system having means in the form of hardware, software, or a combination of software and hardware as described herein or their equivalent.

Thus, the method 400 described herein, and in particular as shown and described in FIG. 4 can be deployed as process software in the context of a computer system or data-processing system as that depicted in FIG. 1-2.

While the present invention has been particularly shown and described with reference to a preferred embodiment, it will be understood by those skilled in the art that various changes in form and detail may be made therein without departing from the spirit and scope of the invention. Furthermore, as used in the specification and the appended claims, the term “computer” or “system” or “computer system” or “computing device” includes any data processing system including, but not limited to, personal computers, servers, workstations, network computers, main frame computers, routers, switches, Personal Digital Assistants (PDA's), telephones, and any other system capable of processing, transmitting, receiving, capturing and/or storing data.

It will be appreciated that variations of the above-disclosed and other features and functions, or alternatives thereof, may be desirably combined into many other different systems or applications. Also that various presently unforeseen or unanticipated alternatives, modifications, variations or improvements therein may be subsequently made by those skilled in the art which are also intended to be encompassed by the following claims.

What is claimed is:

1. A computer-implementable method for unrolling imperfect loop nests, comprising:
categorizing an iteration space associated with at least one dimension of a nested loop into a residual iteration space and a non-residual iteration space utilizing an unroll-and-jam transformation wherein said non-residual iteration space traverses a set of indices for a next dimension of said nested loop;
recursively applying said unroll-and-jam transformation to said next dimension utilizing said non-residual iteration space of said at least one dimension and performing said unroll-and-jam transformation until a last dimension of said nested loops thereof; and
removing said non-residual iteration space and generating code for said residual iteration space of said last dimension in order to obtain a perfect loop nest to thereby provide for an efficient compile time direct loop optimization transformation.

2. The computer-implemented method of claim 1 further comprising:
traversing said set of indices for said next dimension utilizing a slicing loop whenever said next dimension triangularly depends on said at least one dimension of said nested loop.

3. The computer-implemented method of claim 1 wherein said nested loop comprises a loop nest of two or more dimensions.

4. The computer-implemented method of claim 1 wherein said nested loop comprises a plurality of loops with bounds expressed as a linear function of induction variables with respect to outer loops.

5. The computer-implementable method of claim 1, further comprising:
moving at least one intervening code of said nested loop to either a beginning or an end of said nested loop and fusing a plurality of child loops into a single child loop nest when said nested loop is imperfectly nested.

6. The computer-implemented method of claim 1 wherein said set of indices can be either traversed at the beginning of said iteration space as a “head residue” or at the end of said iteration space as a “tail residue”.

7. The computer-implemented method of claim 1 wherein said nested loop comprises a loop nest of two or more dimensions and wherein said nested loop also comprises a plurality of loops with bounds expressed as a linear function of induction variables with respect to outer loops.

8. A system for unrolling imperfect loop nests, comprising:
a processor;
a data bus coupled to said processor; and
a computer-usable medium embodying computer code, said computer-usable medium being coupled to said data bus, said computer program code comprising instructions executable by said processor and configured for:
categorizing an iteration space associated with at least one dimension of a nested loop into a residual iteration space and a non-residual iteration space utilizing an unroll-and-jam transformation wherein said non-residual iteration space traverses a set of indices for a next dimension of said nested loop;
recursively applying said unroll-and-jam transformation to said next dimension utilizing said non-residual iteration space of said at least one dimension and performing said unroll-and-jam transformation until a last dimension of said nested loops thereof; and
removing said non-residual iteration space and generating code for said residual iteration space of said last dimension in order to obtain a perfect loop nest to thereby provide for an efficient compile time direct loop optimization transformation.

9. The system of claim 8, wherein said instructions are further configured for:
traversing said set of indices for said next dimension utilizing a slicing loop whenever said next dimension triangularly depends on said at least one dimension of said nested loop.

10. The system of claim 8, wherein said nested loop comprises a loop nest of two or more dimensions.

11. The system of claim 8, wherein said nested loop comprises a plurality of loops with bounds expressed as a linear function of induction variables with respect to outer loops.

12. The system of claim 8, wherein said instructions are further configured for:
moving at least one intervening code of said nested loop to either a beginning or an end of said nested loop and fusing a plurality of child loops into a single child loop nest when said nested loop is imperfectly nested.

13. The system of claim 8, wherein said set of indices can be either traversed at the beginning of said iteration space as a “head residue” or at the end of said iteration space as a “tail residue”.

14. The system of claim 8, wherein said nested loop comprises a loop nest of two or more dimensions and wherein said nested loop also comprises a plurality of loops with bounds expressed as a linear function of induction variables with respect to outer loops.

15. A computer-usable medium embodying computer program code, said computer program code comprising computer executable instructions configured for:
categorizing an iteration space associated with at least one dimension of a nested loop into a residual iteration space and a non-residual iteration space utilizing an unroll-and-jam transformation wherein said non-residual iteration space traverses a set of indices for a next dimension of said nested loop;
recursively applying said unroll-and jam transformation to said next dimension utilizing said non-residual iteration space of said at least one dimension and performing said unroll-and-jam transformation until a last dimension of said nested loops thereof; and
removing said non-residual iteration space and generating code for said residual iteration space of said last dimension in order to obtain a perfect loop nest to thereby provide for an efficient compile time direct loop optimization transformation.

16. The computer-usable medium of claim 15, wherein said embodied computer program code further comprises computer executable instructions configured for:
traversing said set of indices for said next dimension utilizing a slicing loop whenever said next dimension triangularly depends on said at least one dimension of said nested loop.

17. The computer-usable medium of claim 15, wherein said nested loop comprises a loop nest of two or more dimensions.

18. The computer-usable medium of claim 15, wherein said nested loop comprises a plurality of loops with bounds expressed as a linear function of induction variables with respect to outer loops.

19. The computer-usable medium of claim 15, wherein said embodied computer program code further comprises computer executable instructions configured for:
moving at least one intervening code of said nested loop to either a beginning or an end of said nested loop and fusing a plurality of child loops into a single child loop nest when said nested loop is imperfectly nested.

20. The computer-usable medium of claim 15, wherein said set of indices can be either traversed at the beginning of said iteration space as a “head residue” or at the end of said iteration space as a “tail residue”.
